(19) United States
(12) Patent Application Publication
(10) Pub. No.: US 2025/0142651 A1
(43) Pub. Date: May 1, 2025

(54) TRANSMISSION OF MULTIPLE AUDIO SOURCES THROUGH A DECT SYSTEM

(71) Applicants: 3M INNOVATIVE PROPERTIES COMPANY, St. Paul, MN (US); RTX A/S, Nørresundlby (DK)

(72) Inventors: Darin K. Thompson, Huntersville, NC (US); Vincent Scott Garmon, Waxhaw, NC (US); David A. Amero, Calgary (CA); Robert Heise, Calgary (CA); Qi Tang, Kirkland, WA (US); IIka Müller, Aalborg (DK); Christopher E.B. Meisner, Nibe (DK); Claus K. Vesterholt, Skoerping (DK)

(21) Appl. No.: 18/689,359

(22) PCT Filed: Sep. 14, 2022
(86) PCT No.: PCT/IB2022/058671

§ 371 Date: Mar. 5, 2024

Related U.S. Application Data
(60) Provisional application No. 63/246,938, filed on Sep. 22, 2021.

(51) Int. Cl. H04W 76/14

(52) U.S. Cl. CPC H04W 76/14

(57) ABSTRACT

A first communication device of a plurality of communication devices is described. Each one of the plurality of communication devices other than the first communication device supports at least audio communication at least with the first communication device using at least one of a first communication protocol and a second communication protocol. The first communication device supports the at least audio communication using at least the first communication protocol and the second communication protocol, where the first and second communication protocols are different. The first communication device includes processing circuitry that causes the first communication device to transfer audio one of from a second communication device using the second communication protocol to a third communication device using the first communication protocol and from the third communication device using the first communication protocol to the second communication device using the second communication protocol.

### TECHNICAL FIELD

This disclosure relates to communication networks, and in particular to transmission of multiple audio sources through a Digital Enhanced Cordless Telecommunications (DECT) technology system.

### Introduction

The existing DECT protocol supports mobile wireless communication between communication devices. A typical DECT configuration may include several communication devices, such as phones (handsets) and a corresponding fixed base station. At least two communication devices in a typical DECT configuration may wirelessly communicate with each other via the fixed base station.

Wireless communication has become critical for first responders, such as police officers, firefighters, and paramedics, when responding to an emergency. According to one example, an incident commander may want to communicate with deployed first responders who carry out commands from the incident commander in order to address the emergency. According to another example, firefighters of a group of firefighters moving from an area within the emergency site to a distanced area may want to communicate to each other to coordinate a response to a fire.

In some cases, the incident commander may use more than one communication device, each employing a different technology or communication protocol. For example, an incident commander may use a communication device that only supports a DECT protocol to communicate with deployed first responders, while using a cell phone or a Land Mobile Radio (LMR) to communicate with dispatch. However, if the incident commander receives a call on the cell phone or the LMR, the call cannot be relayed (by the cellphone, the LMR, or the DECT communication device) to the first responders who are using DECT communication devices. In other words, calls and/or audio received using technology other than DECT technology cannot be transferred to communication devices using DECT protocol and vice versa. Therefore, utilizing current DECT technology for communication among first responders during an emergency that requires use of communication devices that employ communication protocols other than DECT can be problematic as the use of multiple protocols/technologies causes difficulty and delay in relaying audio/calls/messages, etc.

### SUMMARY

Some embodiments advantageously provide a method and system for transmission of multiple audio sources through a DECT system.

According to one aspect of the present disclosure, a first communication device of a plurality of communication devices is described. Each one of the plurality of communication devices other than the first communication device supports at least audio communication at least with the first communication device using at least one of a first communication protocol and a second communication protocol. The first communication device supports the at least audio communication using at least the first communication protocol and the second communication protocol. The first and second communication protocols are different. In addition, the first communication device includes processing circuitry that causes the first communication device to transfer audio one of from a second communication device using the second communication protocol to a third communication device using the first communication protocol, and from the third communication device using the first communication protocol to the second communication device using the second communication protocol.

In some embodiments, transferring audio includes summing the transferred audio at least with any one of audio being transmitted by the first communication device and audio being transmitted by the third communication device.

In some other embodiments, the first communication device supports a plurality of communication protocols, and the first and the second communication protocols are included in the plurality of communication protocols. In addition, the processing circuitry further causes the first communication device to any one of rank at least one of the communication protocols of the plurality of communication protocols and select at least one communication protocol of the plurality communication protocols to transfer audio using the selected at least one communication protocol to one of the second communication device and the third communication device. The selecting at least one communication protocol is performed by any one of pre-configuration, a voice command, and a haptic selection.

In one embodiment, the third communication device is a group of communication devices supporting at least the first communication protocol, and the group is user definable. The processing circuitry further causes the first communication device to select at least one communication device of the group of communication devices supporting at least the first communication protocol and transfer the audio from the second communication device using the second communication protocol to the selected at least one communication device of the group of communication devices supporting at least the first communication protocol.

In another embodiment, the processing circuitry further causes the first communication device to maintain at least one address of any one of the first communication device, the second communication device, and each communication device of the group of communication devices supporting at least the first communication protocol.

In some embodiments, the processing circuitry further causes the first communication device to transfer at least an encryption key to the selected at least one communication device and encrypt the audio before transferring the audio.

In some other embodiments, the processing circuitry further causes the first communication device to assign one of a different volume level and a same volume level to audio corresponding to each one of the first communication device, the second communication device, and any communication device of the group of communication devices supporting at least the first communication protocol.

In one embodiment, any communication device of the group of communication devices supporting at least the first communication protocol is configured to receive a communication device configuration. The communication device configuration includes any one of administrator privileges and user privileges. The administrator privileges allow a remote activation of audio transfer including transmitting a configuration command to at least one communication device of the group of communication devices.

In another embodiment, selecting at least one communication device of the group of communication devices supporting at least the first communication protocol includes transmitting at least a packet including a listen bit that one of enables and disables receiving transferred audio at the selected at least one communication device.

In some embodiments, the first communication protocol is a Digital Enhanced Cordless Telecommunications (DECT) protocol, and the second communication protocol one of is and supports Land Mobile Radio (LMR) audio communication, cellular communication, a Bluetooth protocol, and a Wi-Fi protocol.

In some other embodiments, the first communication device is another group of communication devices.

In one embodiment, the first communication device is an inter-crew communication device, the second communication device is any one of a Land Mobile Radio (LMR), a cellular phone, a Bluetooth device, and a Wi-Fi device, and the third communication device is another inter-crew communication device.

According to another aspect of the present disclosure, a method implemented in a first communication device of a plurality of communication devices is described. Each one of the plurality of communication devices other than the first communication device supports at least audio communication at least with the first communication device using at least one of a first communication protocol and a second communication protocol. The first communication device supports the at least audio communication using at least the first communication protocol and the second communication protocol. The first and second communication protocols are different. In addition, the method includes transferring audio one of from a second communication device using the second communication protocol to a third communication device using the first communication protocol and from the third communication device using the first communication protocol to the second communication device using the second communication protocol.

In some embodiments, transferring audio includes summing the transferred audio at least with any one of audio being transmitted by the first communication device and audio being transmitted by the third communication device.

In some other embodiments, the first communication device supports a plurality of communication protocols. The first and the second communication protocols are included in the plurality of communication protocols. In addition, the method further includes ranking at least one of the communication protocols of the plurality of communication protocols and selecting at least one communication protocol of the plurality communication protocols to transfer audio using the selected at least one communication protocol to one of the second communication device and the third communication device. The selecting at least one communication protocol is performed by any one of pre-configuration, a voice command, and a haptic selection.

In one embodiment, the third communication device is a group of communication devices supporting at least the first communication protocol, and the group is user definable. The method further includes selecting at least one communication device of the group of communication devices supporting at least the first communication protocol and transferring the audio from the second communication device using the second communication protocol to the selected at least one communication device of the group of communication devices supporting at least the first communication protocol.

In another embodiment, the method further includes maintaining at least one address of any one of the first communication device, the second communication device, and each communication device of the group of communication devices supporting at least the first communication protocol.

In some embodiments, the method further includes transferring at least an encryption key to the selected at least one communication device and encrypting the audio before transferring the audio.

In some other embodiments, the method further includes assigning one of a different volume level and a same volume level to audio corresponding to each one of the first communication device, the second communication device, and any communication device of the group of communication devices supporting at least the first communication protocol.

In one embodiment, any communication device of the group of communication devices supporting at least the first communication protocol is configured to receive a communication device configuration, which includes any one of administrator privileges and user privileges. The administrator privileges allow a remote activation of audio transfer including transmitting a configuration command to at least one communication device of the group of communication devices.

In another embodiment, selecting at least one communication device of the group of communication devices supporting at least the first communication protocol includes transmitting at least a packet including a listen bit that one of enables and disables receiving transferred audio at the selected at least one communication device.

In some embodiments, the first communication protocol is a Digital Enhanced Cordless Telecommunications (DECT) protocol, and the second communication protocol one of is and supports Land Mobile Radio (LMR) audio communication, cellular communication, a Bluetooth protocol, and a Wi-Fi protocol.

In some other embodiments, the first communication device is another group of communication devices.

In one embodiment, the first communication device is an inter-crew communication device, the second communication device is any one of a Land Mobile Radio (LMR), a cellular phone, a Bluetooth device, and a Wi-Fi device, and the third communication device is another inter-crew communication device.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a schematic diagram of an example system according to one or more embodiments of the present disclosure;

FIG. 2 is a flowchart of an example process in a communication device for transferring audio from one communication device supporting on communication protocol to another communication device supporting another communication protocol according to one or more embodiments of the present disclosure; and

FIG. 3 is another schematic diagram of another example system including a communication device communicating with other communication devices using different communication protocols according to one or more embodiments of the present disclosure.

### DETAILED DESCRIPTION

Before describing in detail exemplary embodiments, it is noted that the embodiments reside primarily in combinations of apparatus components and processing steps related to transmission of multiple audio sources through a DECT system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

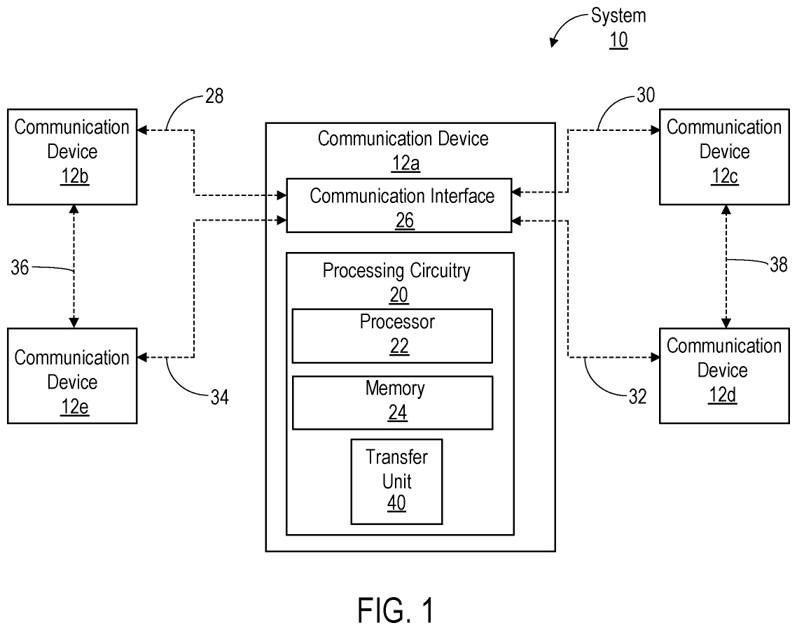

Referring to the drawing figures, in which like elements are referred to by like reference numerals, there is shown in FIG. 1 a schematic diagram of an example system 10 according to one or more embodiments. The system 10 includes multiple communication devices 12, e.g., communication devices 12a-12e (collectively referred to as communication devices 12) where communication device 12a may be in direct communication with each of communication devices 12b, 12c, 12d, and/or 12e such as via one or more of wireless and/or wired communication using one or more communication protocols. Similarly, communication device 12b may be in direct communication with communication device 12e, and/or communication device 12c may be in direct communication with communication device 12d such as via one or more of wireless and/or wired communication using one or more communication protocols.

Communication device 12, e.g., communication device 12a, includes processing circuitry 20. The processing circuitry 20 may include a processor 22 and a memory 24. In particular, in addition to or instead of a processor, such as a central processing unit, and memory, the processing circuitry 20 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 22 may be configured to access (e.g., write to and/or read from) the memory 24, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the communication device 12, e.g., communication device 12a, may further include software stored internally in, for example, memory 24. The software may be executable by the processing circuitry 20. The processing circuitry 20 may be configured to control any of the methods and/or processes described herein and/or to cause such methods, and/or processes to be performed, e.g., by communication device 12. Processor 22 corresponds to one or more processors 22 for performing communication device 12 functions described herein. The memory 24 is configured to store data, programmatic software code and/or other information described herein. In some embodiments, the software may include instructions that, when executed by the processor 22 and/or processing circuitry 20, causes the processor 22 and/or processing circuitry 20 to perform the processes described herein with respect to communication device 12.

In addition, the communication device 12, e.g., communication device 12a, may include a communication interface 26 configured to communicate with at least one other communication device 12, e.g., 12b, 12c, 12d, 12e, such as via one or more of wireless and/or wired communication using one or more communication protocols. More specifically, the communication interface 26 of the communication device 12, e.g., communication device 12a, may communicate with the communication device 12b via communication link 28, with the communication device 12c via communication link 30, with the communication device 12d via communication link 32, and with communication device 12e via communication link 34. Similarly, the communication device 12b may communicate with the communication device 12e via communication link 36, and communication device 12c may communicate with the communication device 12d via communication link 38. Further, communication device 12, e.g., communication device 12a, is configured to communicate with the processing circuitry 20, the processor 22 and the memory 24, to perform the processes described herein with respect to communication device 12.

In some embodiments, communication device 12 supports communication, such as via communication interface 26, using at least one communication protocol. Supported communication protocols include, but are not limited to, any DECT protocol, any protocol supported by LMRs, cellular communication protocols, any protocol of the family of wireless network protocols based on the Institute of Electrical and Electronics Engineers (IEEE) 802.11 family of standards (e.g., Wi-Fi communication protocols), any short-range wireless technology standard (e.g., Bluetooth protocol), and/or any other communication protocol used in wired/wireless communication.

In some other embodiments, communication device 12 may support at least two communication protocols for communication, such as via communication interface 26, with other communication devices 12 that support one of a first communication protocol and a second communication protocol different from the first communication protocol. In a nonlimiting example, communication device 12a, such as via communication interface 26, may communicate with communication device 12c via link 30 using a first protocol, e.g., DECT protocol, and communicate with communication device 12d via link 32 using the first protocol. Further, communication devices 12c and 12d may communicate via link 38 using the first protocol. In addition, communication device 12a may communicate, such as via communication interface 26, with communication device 12b via communication link 28 using a second protocol, e.g., any protocol supported by an LMR. Communication device may also communicate, such as via communication interface 26, with communication device 12e via communication link 34 using the second communication protocol or a third communication protocol (different from the first and second protocols), e.g., a Wi-Fi communication protocol. Further, communication devices 12b and 12e may communicate via communication link 36 using another communication protocol such as a cellular communication protocol.

In addition, system 10 may include a communication device 12, e.g., communication device 12, comprising a transfer unit 40 which is configured to cause the communication device 12 at least to transfer a transmission from at least one communication device 12 using one protocol to at least another communication device using another communication protocol. The transmission may comprise audio, video, data, control information, and configuration information. However, the transmission is not limited to audio, video, data, control information, and configuration information, and may include any other content.

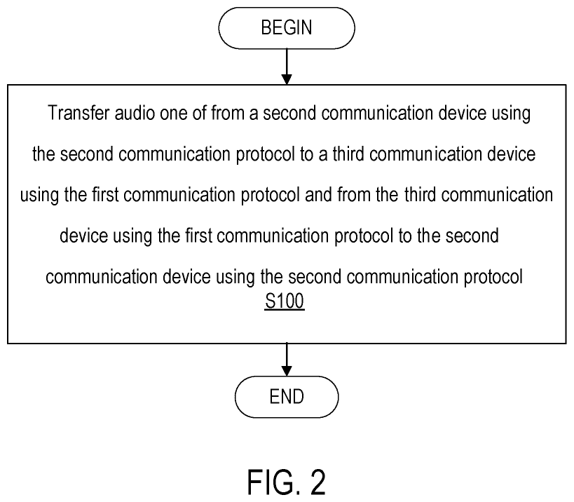

FIG. 2 is a flowchart of an example process in a communication device 12 for transferring audio from one communication device supporting on communication protocol to another communication device 12 supporting another communication protocol. One or more Blocks and/or functions and/or methods performed by communication device 12 may be performed by one or more elements of communication device 12 such as by transfer unit 40 in processing circuitry 20, processor 22, communication interface 26, etc. The example process includes transferring audio (Block S100), such as via transfer unit 40, processing circuitry 20, processor 22, and/or communication interface 26, one of from a second communication device using the second communication protocol to a third communication device using the first communication protocol, and from the third communication device using the first communication protocol to the second communication device using the second communication protocol.

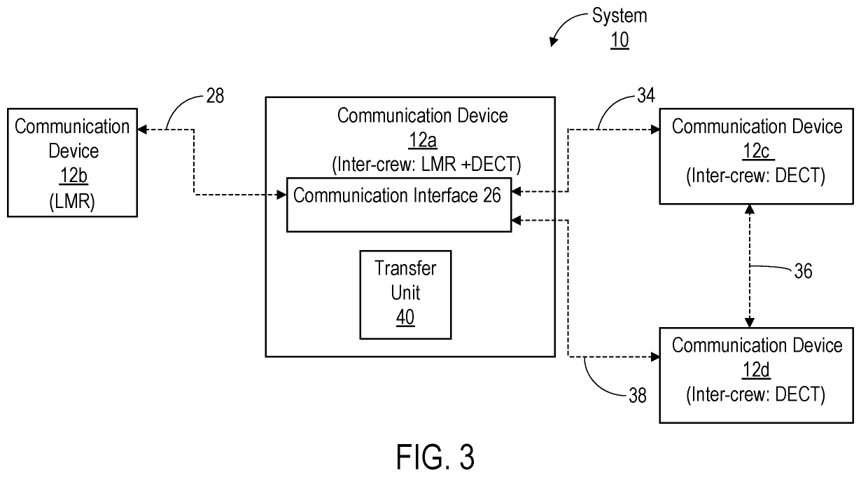

FIG. 3 is another schematic diagram of another example system 10 including a communication device 12 communicating, such as via communication interface 26, with other communication devices 12 using different communication protocols. More specifically, system 10 includes communication device 12a, e.g., an inter-crew communication device supporting any communication protocol used by an LMR and supporting a DECT protocol. System 10 further includes communication devices 12b, 12c, and 12d. Communication device 12b is an LMR. Communication devices 12c and 12b are each an inter-crew communication devices supporting a DECT protocol.

As such, communication device 12, e.g., communication device 12a, may have multiple sources (e.g., the LMR and the communication devices 12c and 12d supporting the DECT protocol) to obtain audio input, e.g., via the communication interface 26. Communication device 12a may take one or more of the various audio inputs, e.g., audio received via communication link 28 from communication device 12b which is an LMR, and utilizes the DECT protocol to further transmit, e.g., via communication device 26 and/or transfer unit 40, the received audio and/or associated information to communication devices 12c and 12d. Communication 12c and 12d being inter-crew communication devices that support the DECT protocol, may or may not have access to the communication device 12b, e.g., the LMR.

Communication device 12a may also take one or more of the various audio inputs, e.g., audio received via communication links 34 and 38 from communication devices 12c and 12d, respectively. The audio received via communication links 34 and 38, e.g., using the DECT protocol, may be transmitted, e.g., via communication device 26 and/or transfer unit 40, to communication device 12b, e.g., the LMR.

Further, in some embodiments communication device 12 may be configured to sum the audio from any one of the communication links with audio on any other communication link. In a nonlimiting example, the audio being received from communication device 12b, e.g., the LMR, may be summed with audio on any one of communication links 34 and 38. Similarly, audio being received on any of communication links 34 and 38 may be summed with audio transmitted to communication device 12b on communication link 28. Any combination of communication links may be used to sum audio. In a nonlimiting example, the DECT protocol supporting full duplex communication allows anyone speaking via communication devices 12a, 12c, and 12d, e.g., while the PTT on the corresponding communication device is depressed, to transmit spoken audio using the DECT protocol. The spoken audio is summed with audio received via any protocol supported by the LMR, such as Bluetooth, on communication link 28 to allow the user to hear all summed audio conversation simultaneously.

Communication device 12 may also be configured to rank/prioritize audio received/transmitted on any one of the communication links 28, 34, 38, and any other communication link. Ranking/prioritizing audio may include muting, merging, and/or assigning predefined volumes to audio received/transmitted on any one of the communication links 28, 34, 38, and any other communication link. Further, ranking/prioritizing audio may also be automatic and/or adaptive and/or based on predefined criteria such as criteria that is preconfigured, e.g., using configuration settings. Preconfiguring may include assigning a relative volume to each communication link 28, 34, 38 and/or corresponding communication device 12 and/or communication protocol and/or user of communication device 12. For example, a first volume may be assigned to a communication protocol, e.g., Bluetooth, and a second volume to another communication protocol, e.g., DECT. In another example, the volume of one audio source may be decreased to emphasize audio from another audio source. For example, the audio from an incident commander's communication device 12 may be prioritized and made louder than the audio from the communication device 12 of a firefighter deployed at the incident site.

In addition, communication device 12 may be configured to receive user input, including user input, e.g., voice commands and/or haptic input, to select one or more specific communication links 28, 34, and 38 and/or communication devices 12. In a nonlimiting example, a group, e.g., a Crew Talk group, may be created, e.g., via Near Field Communication (NFC), where the group defines one or more communication devices 12 and/or user(s) associated with the corresponding communication devices 12 that are included in the group. At least one DECT channel may be associated with the group, where different channels may be assigned according to the country or any other zone where communication device 12 is being used.

In a nonlimiting example, when connecting a communication device 12, e.g., communication device 12a, to another communication system 12, e.g., smart device such as an LMR/LTE device, communication 12 is configured such that an incident commander or any user of communication device 12 can route audio to/from any communication device 12 supporting the DECT protocol, e.g., via transfer unit 40 and/or communication interface. Routing/transferring audio, e.g., via communication interface 26 and/or transfer unit 40, may be remotely activated, e.g., with or without the individual firefighter's communication device 12 being initially configured to route audio to the communication devices 12 supporting the DECT protocol. Remote activation may be preconfigured on a communication device 12 and may be assigned to specific communication devices 12 and/or to specific user access levels, e.g., assigned to users with administrator privileges or any other privileges. Thus, in a nonlimiting example, a communication device 12 may be initially configured or not to route/transfer audio, such as via communication interface 26 and/or transfer unit 40. In another nonlimiting example, the communication device 12 may be configured to route/transfer audio but not enabled to, where enabling routing/transferring of audio is based on user, communication device 12, or any other criterion.

In other words, communication device 12 may allow a user of the communication device 12, e.g., an incident commander, to selectively route audio, e.g., bi-directional audio, to a known communication device 12 and/or user currently on system 10. In order to selectively route audio or for any other purpose, the communication device 12 may support addressing and may maintain a list of addresses, e.g., Internet Protocol (IP) addresses, a DECT address, and/or any other kind of address, including at least one address of at least one communication device 12. Further, selectively routing audio may be configured by including a data packet to send voice/data to a specific communication device 12 and/or user wearing the specific communication device 12. The data packet may include the address of a communication device 12 and/or other information, e.g., security information. For example, communication device 12 may transfer, using the data packet or any other method, one or more encryption keys to a specific communication device 12 that the incident commander is attempting to communicate with. The data packet may also include a listen bit, e.g., to command a specific communication device 12 to listen or not to a specific transmission.

It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings.

1. A first communication device of a plurality of communication devices, each one of the plurality of communication devices other than the first communication device supporting at least audio communication at least with the first communication device using at least one of a first communication protocol and a second communication protocol, the first communication device supporting the at least audio communication using at least the first communication protocol and the second communication protocol, the first and second communication protocols being different from one another, the first communication device comprising processing circuitry that causes the first communication device to:
transfer audio one of:
from a second communication device using the second communication protocol to a third communication device using the first communication protocol; and
from the third communication device using the first communication protocol to the second communication device using the second communication protocol.

2. The first communication device of claim 1, wherein transferring audio includes summing the transferred audio at least with any one of audio being transmitted by the first communication device and audio being transmitted by the third communication device.

3. The first communication device of claim 1, wherein the first communication device supports a plurality of communication protocols, the first and the second communication protocols being included in the plurality of communication protocols, and the processing circuitry further causes the first communication device to any one of:
rank at least one of the communication protocols of the plurality of communication protocols; and
select at least one communication protocol of the plurality communication protocols to transfer audio using the selected at least one communication protocol to one of the second communication device and the third communication device, the selecting at least one communication protocol being performed by any one of pre-configuration, a voice command, and a haptic selection.

4. The first communication device of claim 1, wherein the third communication device is a group of communication devices supporting at least the first communication protocol, the group is user definable, and the processing circuitry further causes the first communication device to:
select at least one communication device of the group of communication devices supporting at least the first communication protocol; and
transfer the audio from the second communication device using the second communication protocol to the selected at least one communication device of the group of communication devices supporting at least the first communication protocol.

5. The first communication device of claim 4, wherein the processing circuitry further causes the first communication device to:
maintain at least one address of any one of the first communication device, the second communication device, and each communication device of the group of communication devices supporting at least the first communication protocol.

6. The first communication device of claim 4, wherein the processing circuitry further causes the first communication device to:
transfer at least an encryption key to the selected at least one communication device; and
encrypt the audio before transferring the audio.

7. The first communication device of claim 4, wherein the processing circuitry further causes the first communication device to:
assign one of a different volume level and a same volume level to audio corresponding to each one of the first communication device, the second communication device, and any communication device of the group of communication devices supporting at least the first communication protocol.

8. The first communication device of claim 4, wherein any communication device of the group of communication devices supporting at least the first communication protocol is configured to receive a communication device configuration, the communication device configuration including any one of administrator privileges and user privileges, the administrator privileges allowing a remote activation of audio transfer including transmitting a configuration command to at least one communication device of the group of communication devices.

9. The first communication device of claim 4, wherein selecting at least one communication device of the group of communication devices supporting at least the first communication protocol includes transmitting at least a packet including a listen bit that one of enables and disables receiving transferred audio at the selected at least one communication device.

10. The first communication device of claim 1, wherein the first communication protocol is a Digital Enhanced Cordless Telecommunications (DECT) protocol, and the second communication protocol one of is and supports Land Mobile Radio (LMR) audio communication, cellular communication, a Bluetooth protocol, and a Wi-Fi protocol.

11. The first communication device of claim 1, wherein the first communication device is another group of communication devices.

12. The first communication device of claim 1, wherein the first communication device is an inter-crew communication device, the second communication device is any one of a Land Mobile Radio (LMR), a cellular phone, a Bluetooth device, and a Wi-Fi device, and the third communication device is another inter-crew communication device.

13. A method implemented in a first communication device of a plurality of communication devices, each one of the plurality of communication devices other than the first communication device supporting at least audio communication at least with the first communication device using at least one of a first communication protocol and a second communication protocol, the first communication device supporting the at least audio communication using at least the first communication protocol and the second communication protocol, the first and second communication protocols being different from one another, the method comprising:
transferring audio one of:
from a second communication device using the second communication protocol to a third communication device using the first communication protocol; and
from the third communication device using the first communication protocol to the second communication device using the second communication protocol.

14. The method of claim 13, wherein transferring audio includes summing the transferred audio at least with any one of audio being transmitted by the first communication device and audio being transmitted by the third communication device.

15. The method of claim 13, wherein the first communication device supports a plurality of communication protocols, the first and the second communication protocols being included in the plurality of communication protocols, and the method further including:
ranking at least one of the communication protocols of the plurality of communication protocols; and
selecting at least one communication protocol of the plurality communication protocols to transfer audio using the selected at least one communication protocol to one of the second communication device and the third communication device, the selecting at least one communication protocol being performed by any one of pre-configuration, a voice command, and a haptic selection.

16. The method of claim 13, wherein the third communication device is a group of communication devices supporting at least the first communication protocol, the group is user definable, and the method further includes:
selecting at least one communication device of the group of communication devices supporting at least the first communication protocol; and
transferring the audio from the second communication device using the second communication protocol to the selected at least one communication device of the group of communication devices supporting at least the first communication protocol.

17. The method of claim 16, wherein the method further includes:
maintaining at least one address of any one of the first communication device, the second communication device, and each communication device of the group of communication devices supporting at least the first communication protocol.

18. The method of claim 16, wherein the method further includes:
transferring at least an encryption key to the selected at least one communication device; and
encrypting the audio before transferring the audio.

19. The method of claim 16, wherein the method further includes:
assigning one of a different volume level and a same volume level to audio corresponding to each one of the first communication device, the second communication device, and any communication device of the group of communication devices supporting at least the first communication protocol.

20. The method of claim 16, wherein any communication device of the group of communication devices supporting at least the first communication protocol is configured to receive a communication device configuration, the communication device configuration including any one of administrator privileges and user privileges, the administrator privileges allowing a remote activation of audio transfer including transmitting a configuration command to at least one communication device of the group of communication devices.

21-24. (canceled)
